(19) United States
(12) Patent Application Publication
(10) Pub. No.: US 2017/0188290 A1
(43) Pub. Date: Jun. 29, 2017

(54) MESSAGE HOPPPING ON PREDEFINED ROUTES USING DSRC BASED VEHICLE-TO-VEHICLE COMMUNICATION

(71) Applicants: M. Imran Hayee, Duluth, MN (US); Attiq Zaman, Bloomington, MN (US); Sean Mooney, San Jose, CA (US)

(72) Inventors: M. Imran Hayee, Duluth, MN (US); Attiq Zaman, Bloomington, MN (US); Sean Mooney, San Jose, CA (US)

(21) Appl. No.: 15/194,550

(22) Filed: Jun. 27, 2016

Related U.S. Application Data
(60) Provisional application No. 62/184,946, filed on Jun. 26, 2015.

(51) Int. Cl. H04W 40/20; H04W 72/00; H04L 1/08; H04W 4/04; H04W 4/00

(52) U.S. Cl. CPC H04W 40/20; H04W 4/046; H04W 4/008; H04L 1/08; H04W 72/005

(57) ABSTRACT

A message is received in a vehicle together with a description of a geographic path that the message is to travel along. The vehicle's geographic position along the geographic path is determined and a message broadcast time for rebroadcasting the message based on the vehicle's geographic position is determined. The message is rebroadcast with the description of the geographic path at the message broadcast time. Many examples and different variations are presented here.

### RELATED APPLICATIONS

This invention is related to a provisional application Ser. No. 62/184,946, filed 26 Jun. 2015, with the same title. It claims priority to that application, and it incorporates by reference all the teaching of that application.

### GOVERNMENT INTEREST

This invention was made with government support under DTRT57-14-C-10027 awarded by the US Department of Transportation. The government has certain rights in the invention.

### BACKGROUND

Packet Source Node (PSN) is stationary or nomadic device that originates a Hopping Packet (Hopping Packet) and transmits over a wireless network. Hopping Node (HN) stands for a stationary or a nomadic device that's capable of retransmitting a received Hopping Packet over a wireless network. The Hopping Nodes traveling in the opposite direction of the Hopping Packet can also participate in hopping. A good example of Packet Source Node is a DSRC Road Side Equipment (RSE) in the traffic intersections. An On Board Unit (OBU) in a car can act as Hopping Nodes for the messages originated from RSE.

Other prior art includes:

A) Performance Evaluation of VeMAC Supporting Safety Applications in Vehicular Networks, by HASSAN ABOUBAKR OMAR1 (Student Member, IEEE), WEIHUA ZHUANG1 (Fellow, IEEE), ATEF ABDRABOU2 (Member, IEEE), AND LI LI3 (Member, IEEE), from Center for Wireless Communications, Department of Electrical and Computer Engineering, University of Waterloo, Waterloo, ON N2L 3G1, Canada, and Department of Electrical Engineering, UAE University, Al-Ain, Abu Dhabi 15551, UAE, and Communications Research Center, Ottawa, ON K2H 8S2, Canada. (Received 31 Mar. 2013; revised 5 Jul. 2013; accepted 9 Jul. 2013. Date of publication 21 Aug. 2013; date of current version 20 Sep. 2013.)

B) VeMAC: A TDMA-Based MAC Protocol for Reliable Broadcast in VANETs, by Hassan Aboubakr Omar, Student Member, IEEE, Weihua Zhuang, Fellow, IEEE, and Li Li, Member, IEEE, published in IEEE TRANSACTIONS ON MOBILE COMPUTING, VOL. 12, NO. 9, Sep. 2013.

However, none of the prior art teaches the details of the invention and features that we have shown below.

### SUMMARY

A message is received in a vehicle together with a description of a geographic path that the message is to travel along. The vehicle's geographic position along the geographic path is determined and a message broadcast time for rebroadcasting the message based on the vehicle's geographic position is determined. The message is rebroadcast as such which already contains the description of the geographic path at the message broadcast time.

In a further embodiment, a vehicle includes a transceiver receiving a message and a geographic message path from another vehicle. A position identification system provides a current geographic position for the vehicle. A processor, using the current geographic position and the geographic message path, sets a broadcast time for broadcasting the received message and the geographic message path to at least one other vehicle.

A vehicle-to-vehicle communication system includes a receiver in a vehicle, receiving a message from a second vehicle. A processor in the vehicle determines a broadcast time to broadcast the received message and before the broadcast time, the receiver in the vehicle receives the message a second time from a third vehicle and in response, the processor cancels the broadcast of the received message at the broadcast time.

### BRIEF DESCRIPTION OF THE DRAWINGS

FIG. 1 is a schematic diagram showing a hopping route define by rectangular regions.

FIG. 2 is a diagram showing hopping time windows and hopping time sub-windows.

FIG. 3 is an example of possible and actual message hopping across multiple vehicles.

FIG. 4 shows a message path divided into different-sized segments.

FIG. 5 shows time windows for a message path with different-sized segments.

FIG. 6 shows multiple message paths for a single message.

FIG. 7 shows a vehicle positioned within a segment of a message path and the geometric elements used to determine the vehicles position in accordance with one embodiment.

FIG. 8 provides an example of message hopping in embodiments in which the time windows of sub-segments are limited to service windows.

FIG. 9 provides a block diagram of elements used in vehicle-to-vehicle message hopping.

FIG. 10 provides a system for broadcasting, according to an embodiment of the invention.

FIG. 11 provides a system for segmentation, according to an embodiment of the invention.

FIG. 12 provides a system for re-broadcasting, according to an embodiment of the invention.

FIG. 13 provides a system for geographical segmentation, according to an embodiment of the invention.

FIG. 14 provides a system for hopping node, according to an embodiment of the invention.

FIG. 15 provides a system for segmenting the curve, according to an embodiment of the invention.

FIG. 16 provides a system for a vehicle, according to an embodiment of the invention.

FIG. 17 provides a system for hopping node, according to an embodiment of the invention.

FIG. 18 provides a system for hopping route, according to an embodiment of the invention.

FIG. 19 provides a system for region determination, according to an embodiment of the invention.

FIG. 20 provides a system for hopping time window, according to an embodiment of the invention.

FIG. 21 provides a system for hopping algorithm, according to an embodiment of the invention.

### DETAILED DESCRIPTION

In accordance with several embodiments, Road-Side Equipment (RSE) transmits messages like a Traveler Information Message (TIM) over Dedicated Short Range Communication (DSRC) wireless technology and these messages are extended along a message path using message hopping in which Hopping Nodes (HNs) rebroadcast the messages they receive. The Hopping Nodes can include On-Board Units (OBU's) carried by vehicles on a road, other RSE devices located along the road or DSRC repeaters.

The messages are referred to as Hopping Packets. To implement hopping of the Hopping Packets over a wireless network on the predefined route or path without having Hopping Nodes modify anything in the Hopping Packet, each Hopping Node is assigned a specific time frame or Hopping Window (HW) during which the Hopping Node is allowed to rebroadcast a Hopping Packet.

The parameters defined below will be included in the Hopping Packet or Hopping Header (HH) that's attached to the Hopping Packet to uniquely identify the Hopping Packet, to allow each Hopping Node to calculate the delta time since the Hopping Packet was transmitted from the Packet Source Node or Source, to allow each Hopping Node to determine which path segment the Hopping Node is within and the position of the Hopping Node within that path segment as well as to determine its rebroadcast time:

Packet Source Node Identifier (For example, a MAC address of the Packet Source Node device)

Packet Source Node Reference Time (The time when the Hopping Packet was initially broadcast by the Packet Source Node)

Hopping Sequence Number (A unique identifier for the Hopping Packet that optionally indicates an order for the Hopping Packets broadcast by the Packet Source Node)

Hopping route (geographic definitions for a sequence of shaped regions)

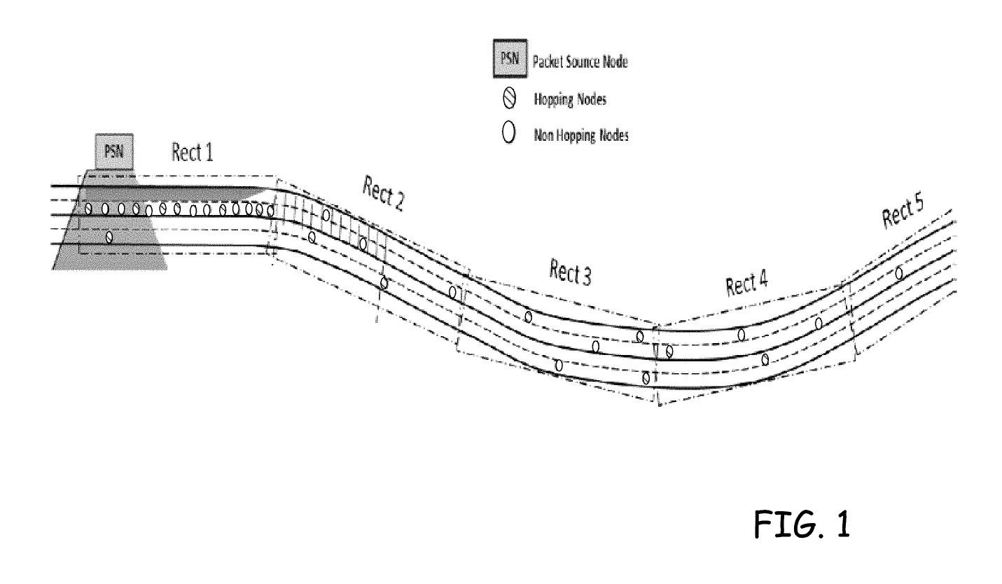

To implement this design, the intended route for a Hopping Packet, which typically follows a road or a collection of roads, is divided into a sequence of shaped geographic regions as shown in FIG. 1. In accordance with one embodiment, the shaped geographic regions are rectangles, however, other shapes may be used. The shaped geographic regions are assigned a number from 1 to M where the number 1 is assigned to the first geographic region, which includes the Packet Source Node and M is assigned to the last geographic region that the Hopping Packet should be broadcast from. Please note that this scheme can work to hop any Hopping Packet as long as the hopping route (sequence of geographic regions) are predefined in the Hopping Packet or a Hopping Header (HH) that's attached to the Hopping Packet.

Adjacent rectangles may overlap each other due to curvature of the road since some embodiments use rectangular regions and not quadrilateral regions. Please note that quadrilateral regions can also be used but as far as hopping is concerned, using such shapes will not gain any additional advantage. Using quadrilateral regions will only require more parameters to define the quadrilateral region in the Hopping Packet or attached Hopping Header and also will add more processing burden on each Hopping Node to figure out which quadrilateral region the Hopping Node belongs to.

In one embodiment, the regions are trapezoid or parallelogram or diamond shape. In one embodiment, the regions are overlapping. In one embodiment, the regions are not overlapping. In one embodiment, the regions are the same size. In one embodiment, the regions are not the same size. In one embodiment, the regions are extracted from a basic shape, with parameters for scaling or rotation or skew, to generate other regions from the base region. In one embodiment, the regions are based on parametric formulas applied on a base region. For example, one can start from a rectangle with size A×B, then scale each side by a and b, which produces a rectangle with the size of aA×bB. Or, in another example, the rectangle is tilted as a parallelogram, with 30 degrees angle with respect to the original side of the rectangle, having the same exact side lengths as the original rectangle, i.e., A and B.

To explain the hopping algorithm, first assume that the rectangular regions are of equal length. This is possible for small curvature roads. Assume the wireless technology used has a practical range of 500 m that is experienced in the field. Each rectangular region is further sub-divided into virtual sub-segments in such a way that length of each sub-segment is around 250 m. The 250 m distance is chosen so that two Hopping Nodes on opposite ends of two consecutive sub-segments can communicate with each other. This distance can be scaled according to the practical range of the wireless technology used.

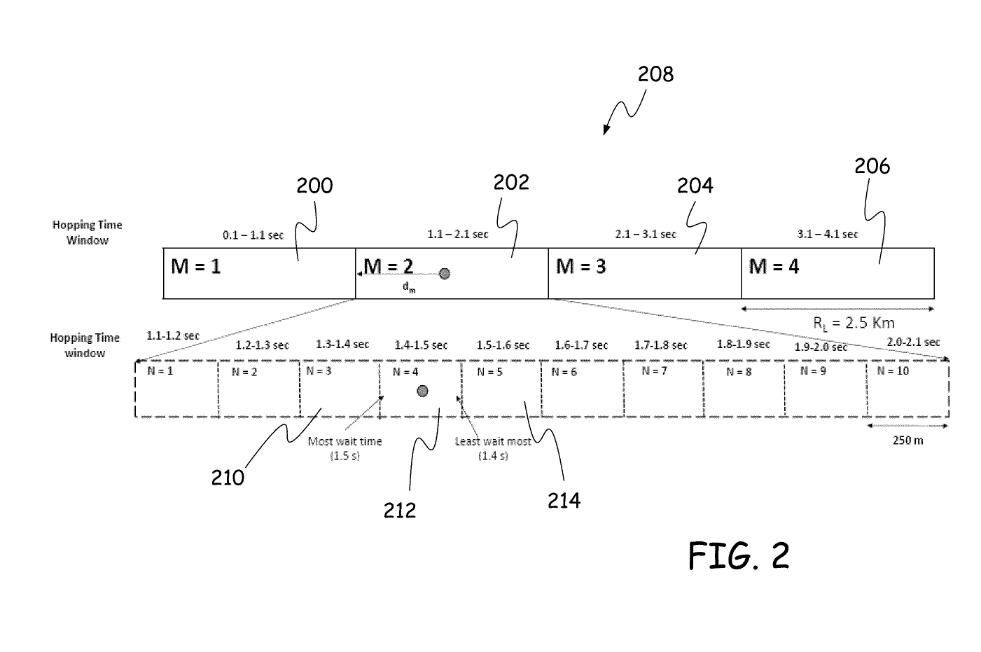

FIG. 2 shows rectangular geographic regions 200, 202, 204 and 206 of a Hopping Packet path 208. As shown for region 202, each region is divided into rectangular sub-regions such as sub-regions 210, 212 and 214, for example. Rectangles and sub-rectangles are shown in FIG. 2, but other shapes can be used for both the regions and the sub-regions. In FIG. 2 the length of each rectangular region has been selected to be 2.5 km so that each rectangle can be divided into 10 sub-rectangles. However, other lengths and different numbers of sub-regions can be used. Specific numbers are used herein to explain the functionality of the hopping method but the embodiments are not limited to these specific numbers.

As shown in FIG. 2, the regions are assigned a number, M, from 1 to the total number of regions along the path and each sub-region is assigned a number, N, from 1 to the total number of sub-regions in the region.

Each sub-region is assigned a hopping time window that defines a time span during which Hopping Nodes in the sub-region are allowed to rebroadcast messages they have received. Each hopping time window is described by a “Lower Limit (LL)” time and an “Upper Limit (UL)” time, which are calculated as following

Lower Limit (LL)_{M,N}=(M−1)+0.1(N) (1)

Upper Limit (UL)_{M,N}=LL+0.1 (2)

### Where

M is number of the region in which the Hopping Node is present

N is the number of the sub-region in which the Hopping Node is present

From equations 1 and 2 and FIG. 2, it can be seen that the Lower Limit and the Upper Limit of the sub-regions do not overlap, even across region borders, and that the lower limit of the sub-regions increases, the further the sub-region is from the Packet Source Node. In addition, the lower limit of the first sub-region of the first region is equal to 100 msec, indicating that there is at least some delay in initially rebroadcasting the Hopping Packet.

In general form, we have the following formulation, with parameters p and q, in one embodiment:

Lower Limit (LL)_{M,N}=(M−1)+q(N) (1a)

Upper Limit(UL)_{M,N}=LL+p (2a)

In a special case of the above, we have, with parameter q, in one embodiment:

Lower Limit (LL)_{M,N}=(M−1)+q(N) (1b)

Upper Limit (UL)_{M,N}=LL+q (2b)

In order for a Hopping Packet to be rebroadcast by a Hopping Node, the Hopping Packet must be received by the Hopping Node before the Lower Limit of the time window for the Hopping Node. If a Hopping Packet is received between the Lower Limit and Upper Limit, it means that another Hopping Node within the same sub-region has rebroadcasted or hopped the Hopping Packet. To prevent a message broadcast storm in which large numbers of Hopping Nodes repeatedly rebroadcast the same Hopping Packet to each other, embodiments herein prevent a Hopping Node from broadcasting a Hopping Packet if the Hopping Node receives the Hopping Pocket from another Hopping Node within the same sub-region. Furthermore, if the Hopping Packet is received after the Upper Limit of the time window for the Hopping Node, the Hopping Packet was broadcast by a Hopping Node that is further along the path or route for the Hopping Packet. As a result, the receiving Hopping Node will not rebroadcast the Hopping Packet if it is received after the Upper Limit of the Hopping Node's time window.

Under various embodiments, each Hopping Node determines its own Hopping Wait Time or Broadcast Time, that defines when the Hopping Node will broadcast the Hopping Packet it received. In accordance with one embodiment, the Hopping Wait Time is calculated relative to the Packet Source Node Reference Time and represents the total time that is to elapse from when the Packet Source Node transmitted the Hopping Packet to when the Hopping Node broadcasts the Hopping Packet. This Hopping Wait Time has two components. The first component is the Upper Limit of the time window of the sub-segment that the Hopping Node is in. This represents the maximum Hopping Wait Time for any Hopping Node in the Hopping Node's sub-segment. This maximum Hopping Wait Time is then reduced so that Hopping Nodes that are further from the Packet Source Node, and thus further from the beginning of the current sub-segment, have shorter Hopping Wait Times. In addition, the reduction in the Hopping Wait Time should be such that a Hopping Node at the end of the sub-segment furthest from the Packet Source Node has a Hopping Wait time equal to the Lower Limit of the time window for the sub-segment. This results in the Hopping Wait Time (HWT) being calculated as:

$$HWT = LL + 0.1 - \frac{( {D}_{M} ( N - 1 ) 250 )}{250} \times ( 0.1 ) \qquad ( 3 )$$

Where D_{M} is the perpendicular distance from the location of the Hopping Node to the beginning of the region, M, in which Hopping Node is present, N is the number assigned to the sub-region in which the Hopping Node is present, each sub-region has a length of 250, and the span of the time-window for each sub-region is 0.1.

The formulation above has the following general form, with parameters Q and p, e.g., with Q in the range of 50 to 1000, as an example:

$$HWT = LL + p - \frac{( {D}_{M} - ( N - 1 ) Q )}{Q} \times p \qquad ( 3 a )$$

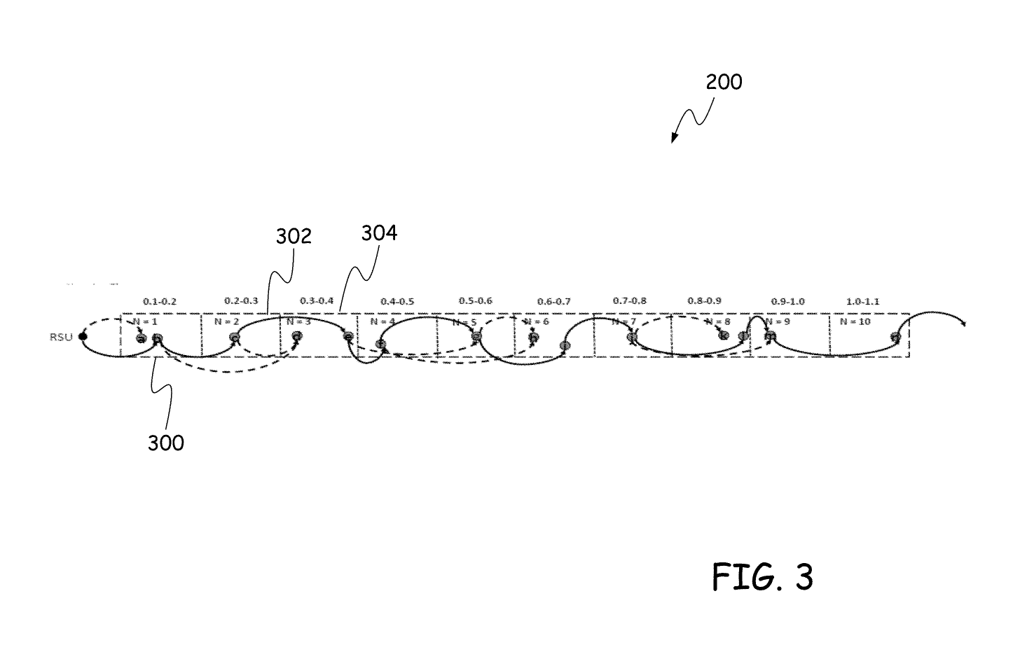

FIG. 3 provides an example of a Hopping Packet being rebroadcasted or hopped by Hopping Nodes within region 200 of FIG. 2.

Initially, the Hopping Packet is transmitted from the Packet Source Node which is present at the beginning of the region 200 (M=1) and is received by Hopping Nodes “a” and “b” in the first sub-region 300 (N=1) at substantially the same time. Upon receiving the Hopping Packet, Hopping Nodes “a” and “b” determine a respective Hopping Waiting Time based on their respective positions within sub-region 300. Hopping Nodes “a” and “b” will then wait for their respective Hopping Waiting times to expire. Since Hopping Node “b” has a larger distance from the beginning of region 200 compared to Hopping Node “a”, Hopping Node “b” will have a shorter Hopping Waiting Time than Hopping Node “a”. Consequently, Hopping Node “b” will broadcast the Hopping Packet before the Hopping Waiting Time for Hopping Node “a” expires.

Now suppose the Hopping Packet broadcast by Hopping Node “b” is received by Hopping Nodes “a”, “c” and “d”. Since “a” will receive this Hopping Packet inside its hopping window time (0.1-0.2 s), it will recognize that this Hopping Packet has been hopped or broadcast by a Hopping Node that is within its own sub-region. In general, the window time is T, with a range of 0.01 to 1 s, as an example. To prevent multiple Hopping Nodes in the same sub-region from broadcasting the same Hopping Packet, Hopping Node “a” will cancel the Hopping Waiting Time and will not broadcast the Hopping Packet. On the other hand Hopping Nodes “c” and “d” will determine respective Hopping Waiting Times based on their reception of the Hopping Packet broadcast by Hopping Node “b”. The Hopping Waiting Time for Hopping Node “c” will be smaller than that of Hopping Node “d” because Hopping Node “c” is in sub-region 302 but Hopping Node “d” is in sub-region 304. Since sub-region 302 is closer to the beginning of region 200, it has an Upper Limit to its time window that is the same as the Lower Limit of sub-region 304. As a result, Hopping Node “c” has a shorter Hopping Wait Time than Hopping Node “d”. Hopping Node “c” will therefore broadcast the Hopping Packet before the Hopping Waiting Time of Hopping Node “d” expires.

Assume this Hopping Packet broadcast by Hopping Node “c” is received by both Hopping Nodes of sub-region 304 (“d” and “e”). Note that Hopping Node “d” has previously received this Hopping Packet and as a result is currently waiting for its Hopping Waiting Time to expire so that it can broadcast the Hopping Packet. However, Hopping Node “e” has not previously received this Hopping Packet. As a result, upon receiving the Hopping Packet from Hopping Node “c”, Hopping Node “e” determines its Hopping Wait Time for the Hopping Packet and begins to wait for the Hopping Wait Time to expire. Because Hopping Node “e” is further from the beginning of region 200 and therefore is further from the beginning of sub-region 304, the Hopping Wait Time for Hopping Node “e” will be shorter than the Hopping Wait Time for Hopping Node “d”. This is true even though Hopping Node “d” received the Hopping Packet before Hopping Node “e”.

When the Hopping Wait Time for Hopping Node “e” expires, Hopping Node “e” broadcasts the Hopping Packet. The Hopping Packet is once again received by Hopping Node “d”. However, this time, upon receiving the Hopping Packet, Hopping Node “d” determines that the Hopping Packet was broadcast by a Hopping Node within the same sub-region 304 as Hopping Node “d”. As a result, Hopping Node “d” ceases its waiting process and cancels the broadcast of the Hopping Packet.

### 2.1. Regions for Curved Roads

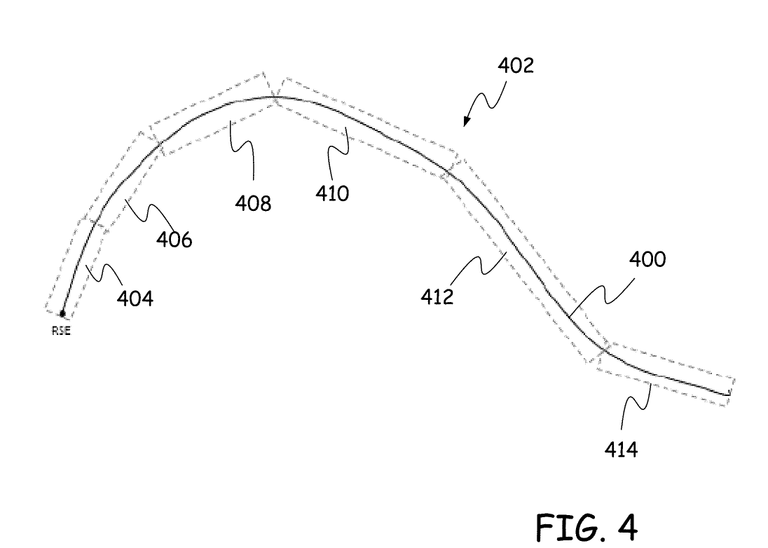

In the embodiments above, each region had the same geographic length and all of the sub-regions had the same geographic length. But if the curvature of a road is larger, then using same-sized regions may be less than ideal. In other embodiments, different geographic lengths are used for different respective regions. Consider for example FIG. 4 where a curved road 400 is shown which has a considerable amount of curvature. To accommodate this kind of road, it is more appropriate to define the route 402 for the Hopping Packet with regions 404, 406, 408, 410, 412 and 414 of variable length. In FIG. 4, it can be seen quite clearly that regions 404, 406 and 408 are not the same length as region 412. In general, the length of each region will depend upon the curvature of the road—the larger the curvature is, the smaller will be the region length. So, for an increased curvature of R, the rectangle side reduces proportional to (1/R), in one embodiment. For the curved region, the number of rectangles increases proportional to R, for a given linear distance, in one embodiment. Or, in general, for an increased curvature of R, the rectangle side reduces proportional to (1/R)^{w}, where w is the higher power, i.e., w>1, in one embodiment.

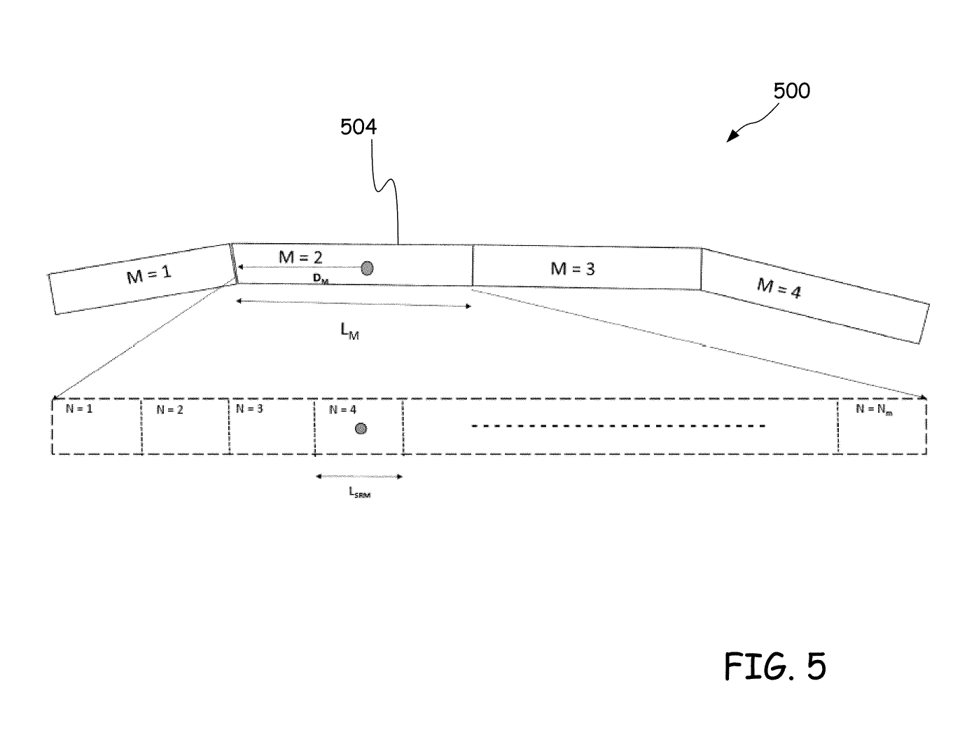

When regions with different lengths are used, the number of sub-regions and/or the length of those sub-regions will also be different in each region. FIG. 5 shows the sub-regions for a region 504 of a Hopping Packet route 500. In FIG. 5, region 504 has a length L_{M}, a number of sub-regions, N_{M}, with each sub-region having a geographic length L_{SRM}. In one embodiment, the length L_{SRM} is variable for the same sub-region or is variable for different sub-regions.

Each Hopping Node, upon receiving a Hopping Packet, calculates the number of sub-regions in each of the regions prior to its location and uses the number of sub-regions to determine the Lower Limit and Upper limit of the Hopping Node's time window and to calculate the Hopping Node's Hopping Time Window.

For a region, the number of sub-regions and their lengths can be calculated using the following formulae:

$$\begin{matrix}{N}_{M} = ceil ( \frac{{L}_{M}}{250} ) & ( 4 a ) \\ {L}_{SRM} = \frac{{L}_{M}}{{N}_{M}} & ( 4 b ) \\ N = ceil ( \frac{{D}_{M}}{{L}_{SRM}} ) & ( 4 c )\end{matrix}$$

### Where,

N_{M} is number of sub-regions in a given region;

L_{M} is the length of the region;

L_{SRM} is the length of each sub-region;

N is the sub-region containing the Hopping Node; and

D_{M} is the perpendicular distance from the position of the Hopping Node to the beginning of the region.

In one embodiment, in general, we have the following, with the Q parameter (as was also used above):

$${N}_{M} = ceil ( \frac{{L}_{M}}{Q} ) \qquad ( 4 aa )$$

Once N_{M} and N are calculated, the Lower and Upper limits of the Hopping Window for the Hopping Nodes sub-region can be found by slightly modifying equations (1) and (2), i.e.

Lower Limit (LL)=Σᵢ₌₁^{M-1}(N_{M}(i)(0.1))+(0.1)N (5)

Upper Limit (UL)=LL+0.1 (6)

And the Hopping Wait Time (HWT) can now be calculated as

$$HWT = LL + .1 - ( \frac{{D}_{M} - ( N - 1 ) ( {L}_{SRM} )}{{L}_{SRM}} ) \times 0.1 \qquad ( 7 )$$

Using this technique, the length of the sub-regions will generally be less than 250 m to accommodate practical hopping as explained later.

In one embodiment, in general, we have the following, with the p parameter (as was also used above):

Lower Limit (LL)=Σᵢ₌₁^{M-1}(N_{M}(i)p)+(p)N (5a)

Upper Limit (UL)=LL+p (6a)

And the Hopping Wait Time (HWT) can now be calculated as:

$$HWT = LL + p - ( \frac{{D}_{M} - ( N - 1 ) ( {L}_{SRM} )}{{L}_{SRM}} ) \times p \qquad ( 7 a )$$

### 2.2. Multiple Geographical Routes

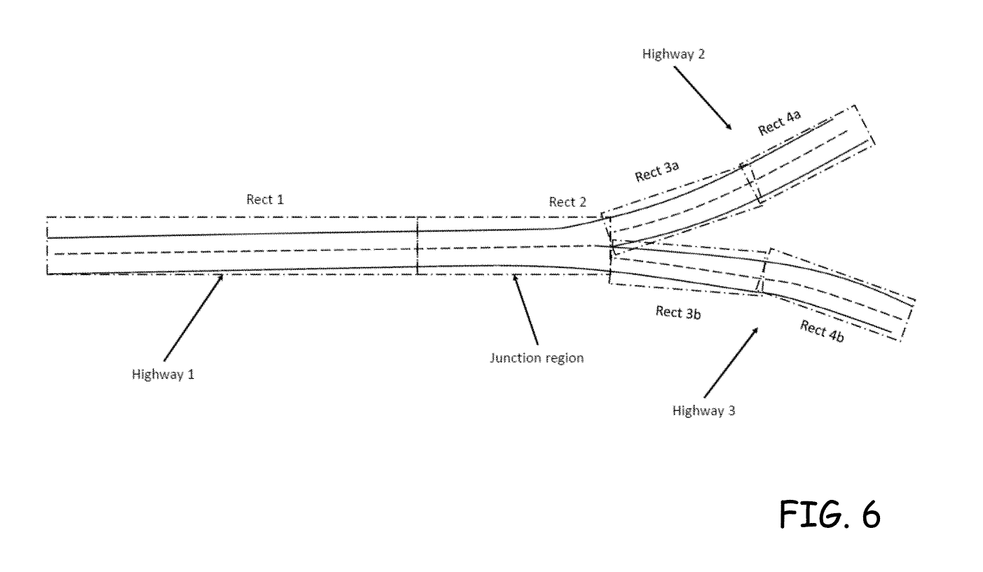

In the embodiments above, HP is only broadcasted on a single geographic route, but it is possible to broadcast a single Hopping Packet along more than one geographical route at the same time. Consider for example FIG. 6, in which a hopping packet is hopped along highway 1 which branches to two highways 2, and 3. If desired, a message could be hopped to both highway 2 and 3 beyond the junction region. In such case, both geographic routes will be included in the HP so that a hopping node on both routes can hop the HP. Similarly, there could be more than 2 hopping routes. As long as a geographic route is encapsulated in HP, it can be hopped. Please also note that the multiple geographic routes could be totally independent and may not have any common regions.

### 2.3. Calculations to Find Position of Hopping Node in a Region

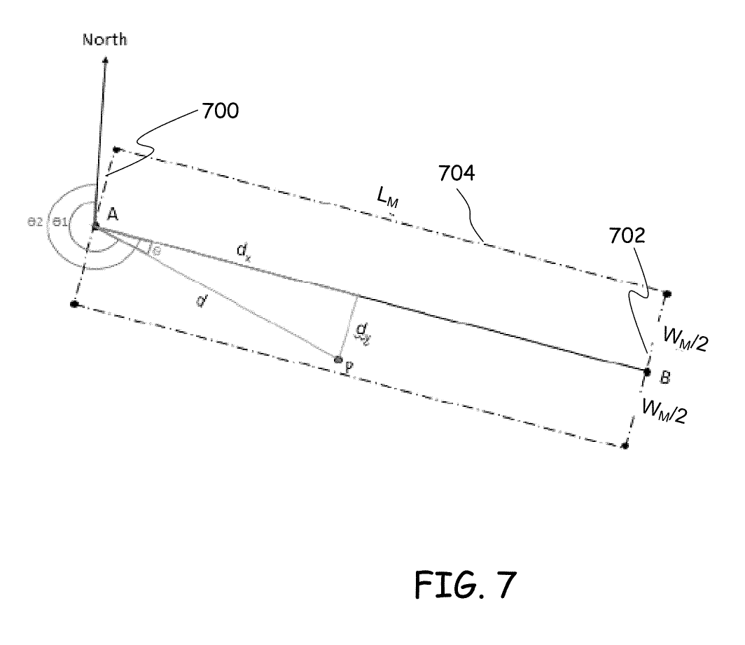

To perform the calculations for LL and HWT, the Hopping Node must be able to determine what region it is in and its position in that region. The Hopping Packet, includes a description of each region that in one embodiment includes the length, W_{M}, and the geographic locations of the mid points, A and B, of the sides 700 and 702, as well as the length, L_{M}, of the sides 704 as shown in the FIG. 7. The dotted lines show the actual region which these parameters represent.

For example, assume point P is the position of the Hopping Node, where the Hopping Node has been determined from a positioning system such as a Global Positioning System. To determine if it is in the region and its position in the region, it:
first calculates the distance between A and P (d);
Then calculates the direction of a vector from A to P=θ1;
Then calculates the direction of a vector from A to B=θ2;
If θ1≦θ2 [point ‘P’ is below the center of the region], then calculate θ=θ2−θ1;
If θ2≦θ1 [point ‘P’ is in above the center of the region], then calculate θ=θ1−θ2;
If 90°<θ then, Hopping Node is outside of the region;
   Now if 0°≦θ≦90° then calculate dₓ and d_{y} using

dₓ=(d)(cos θ) (8a)

d_{y}=(d)(sin θ) (8b)
If dₓ≦L_{M} and d_{y}≦W_{M}/2 then ‘P’ is inside the region.
   Note: dₓ=D_{M} for region M.

Please note that if the shape region is a trapezoid or of any other shape, an appropriate mathematical formulation can be devised to find out if the HN is within the region of interest. Essentially, the same logic and procedure as above is followed with respect to the deformed or tilted or skewed rectangle in FIG. 7.

### 2.4. Hopping Algorithm Implementation

The hopping algorithm is designed based on the assumption that the Hopping Packet will be a read-only message for all Hopping Nodes, meaning they cannot change or edit anything in the Hopping Packet or the attached Hoping Header. The Hopping Packet or the attached Hopping Header will contain enough information for the Hopping Nodes to decide “if and when” to hop/broadcast the Hopping Packet.

The hopping algorithm works in the following way:
1. A Hopping Node after receiving the Hopping Packet, finds which region or segment ‘M’ it is in. The Hopping Node then calculates sub-regions ‘N’ and ΔT, where ΔT is given by

ΔT=Current time−Packet Source Node Reference Time

Please note that the Packet Source Node Reference Time is carried by the Hopping Packet or attached Hopping Header.
2. Now, once the Hopping Node has established that it is inside region ‘M’, the Hopping Node will calculate the lower limit (LL) of its sub-region's Hopping time window and the Hopping Node's Hopping Wait Time (HWT) by using eq. (5) and eq. (7) receptively.
3. If ΔT>LL, then the Hopping Node will not broadcast the Hopping Packet.
4. If ΔT<LL, then the Hopping Node will wait for (HWT−Current Time) before broadcasting said packet.
5. During the wait time, if the Hopping Node receives the same packet again, then it does not wait anymore, and repeats the whole process from step 1.
6. During the wait time, if Hopping Node receives a different packet, then it calculates HWT for that packet, as well, and hops both packets at their respective hopping times.
   Note: In this hopping algorithm, Hopping Nodes that are inside the regions will participate in hopping regardless of their moving direction.

### 3. Problem of Channel Switching Timing:

Now another issue which appears when using DSRC technology for vehicle-to-vehicle (V2V) communication is that in every 100 msec, T₁, a Hopping Node can only broadcast a Hopping Packet during a Service time window that is only 50 msec long, T₂. The other 50 msec are consumed by a control time window during which the Hopping Nodes may not broadcast Packets.

In one embodiment, T₂<T₁, in general.

To accommodate the control time window and ensure that the hopping (transmission and reception of packet) always takes place during the service time window, the lower limits of the hopping windows are redefined as:

Lower Limit (LL)=Σᵢ₌₁^{M-1}(N_{M}(i)(0.1))+(0.1)N+0.05 (9)

And HWT is calculated using

$$HWT = LL + 0.5 - ( \frac{{D}_{M} - ( N - 1 ) ( {L}_{SRM} )}{{L}_{SRM}} ) \times 0.05 \qquad ( 10 )$$

### Where

L_{SRM} is the length of each sub-rectangle

N is the sub-rectangle in which the vehicle is

D_{M} is the perpendicular distance from the position point of vehicle to the left side of rectangle M.

In general form, we have, as an embodiment:

Lower Limit (LL)=Σᵢ₌₁^{M-1}(N_{M}(i)(p))+(p)N+f (9a)

And HWT is calculated using

$$HWT = LL + f - ( \frac{{D}_{M } - ( N - 1 ) ( {L}_{SRM} )}{{L}_{SRM}} ) \times f \qquad ( 10 a )$$

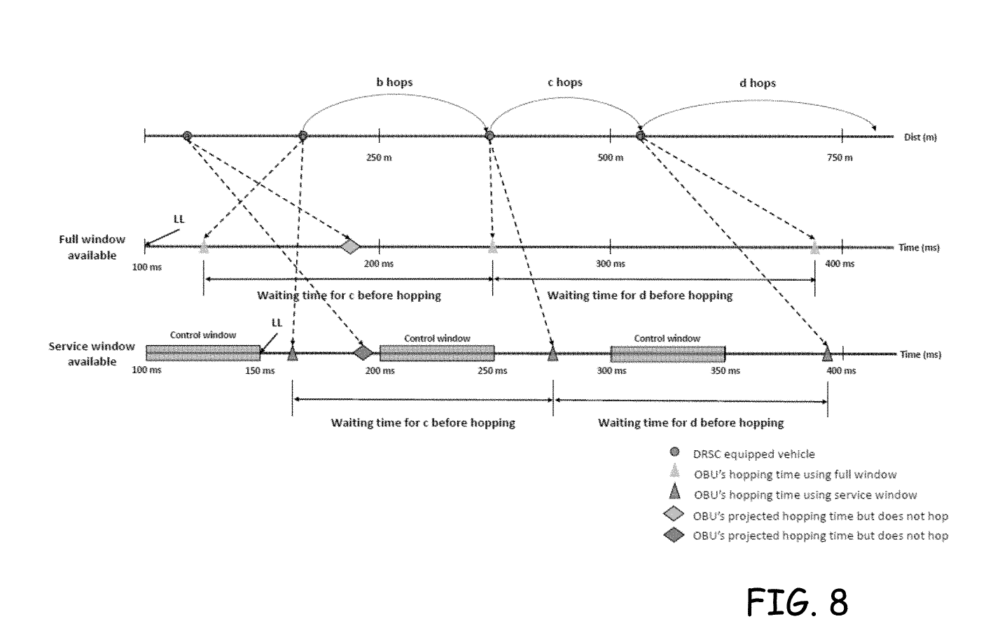

Consider FIG. 8 which explains the modified method to account for the control time windows. Initially both Hopping Nodes “a” and “b” receive a Hopping Packet but since HWT of “b” will be smaller than that of “a”, Hopping Node “b” will hop the Hopping Packet first. As can be seen in FIG. 8, the timing windows are shrunk from 100 msec to 50 msec when using only the service time windows. The hopping time for “b” would be around 125 msec when using full Hopping Time windows but since that hopping time will occur in the middle of the control timing window, the Hopping Node cannot broadcast the Hopping Packet until the control timing window expires and the service time window starts. Therefore, the hopping time is shifted to about 165 msec.

Important points to be noted:

1) Please note that this solution assumes that Control and Service windows are aligned in the Packet Source Node and all Hopping Nodes at all time.

2) Please also note that we will use the effective hopping window to be 50 to 99 msec instead of 50 to 100 msec. This is to ensure that in the worst case, if a Hopping Node transits at the end of the Service window, there is enough time for the next Hopping Nodes to receive that packet before Service window time expires. This change require a modification to the computation of the Hopping Wait time to:

$$HWT = LL + 0.49 - ( \frac{{D}_{M} - ( N - 1 ) ( LSR )}{{L}_{SR}} ) \times 0.049 \qquad ( 11 )$$

In general form, we have, as an embodiment:

$$HWT = LL + {f}^{′} ( \frac{{D}_{M} - ( N - 1 ) ( {L}_{SR} )}{{L}_{SR}} ) \times {f}^{′} \qquad ( 11 a )$$

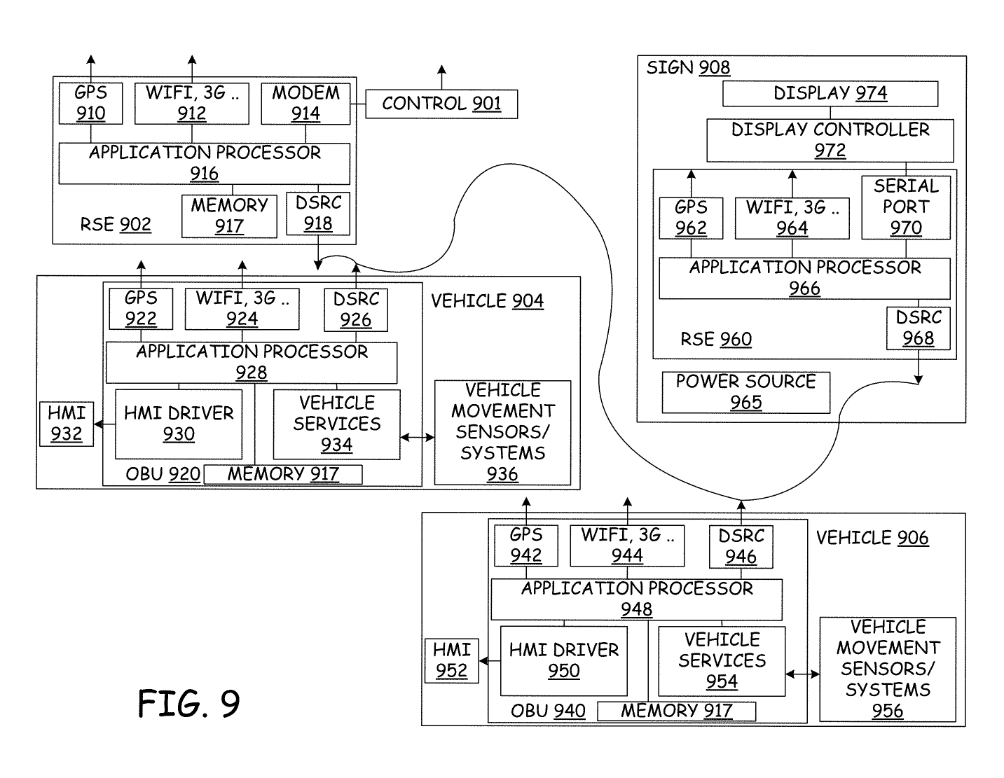

FIG. 9 provides a block diagram of roadside equipment (RSE) 902, two vehicles 904 and 906, and a portable road sign (DSRC-equipped PCMS) 908 that can be used in accordance with various embodiments.

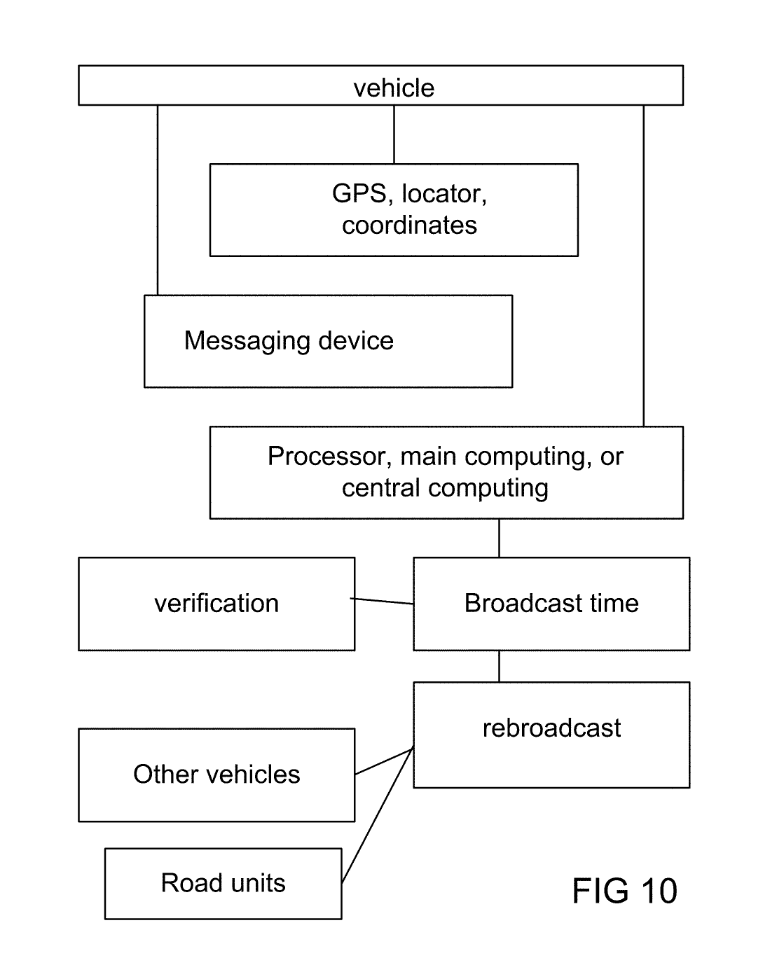

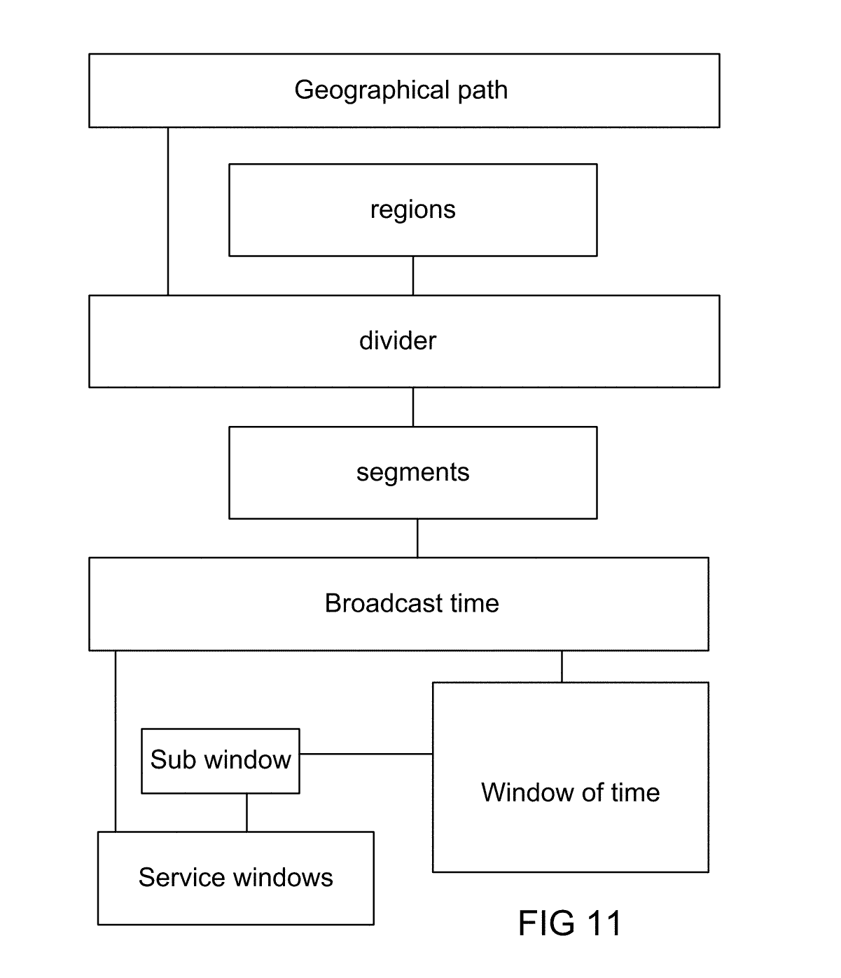

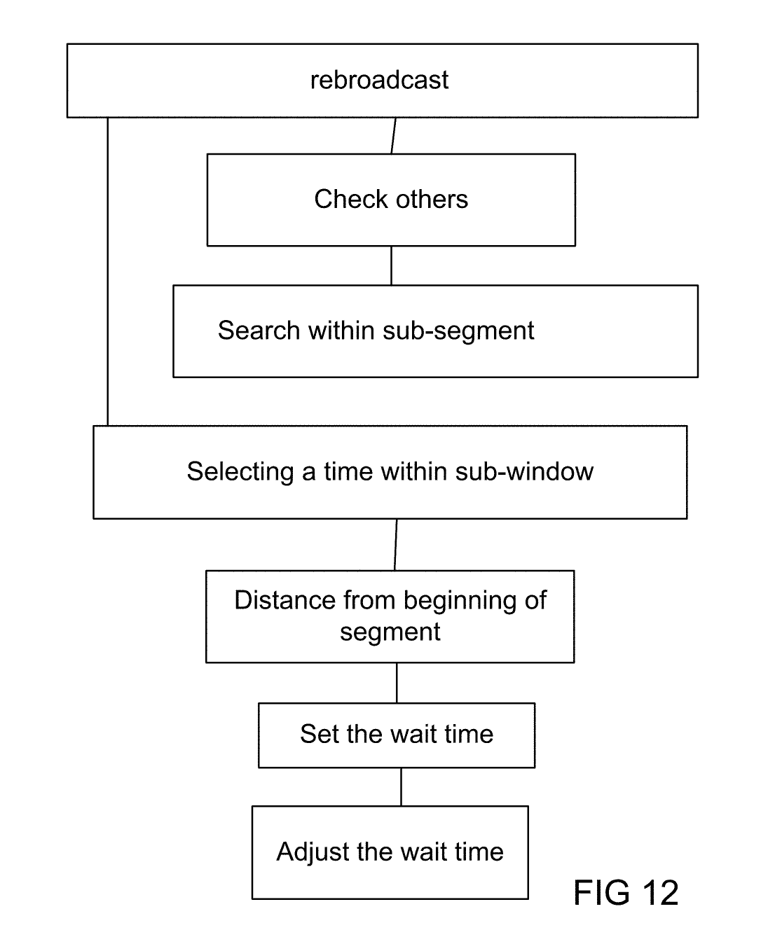

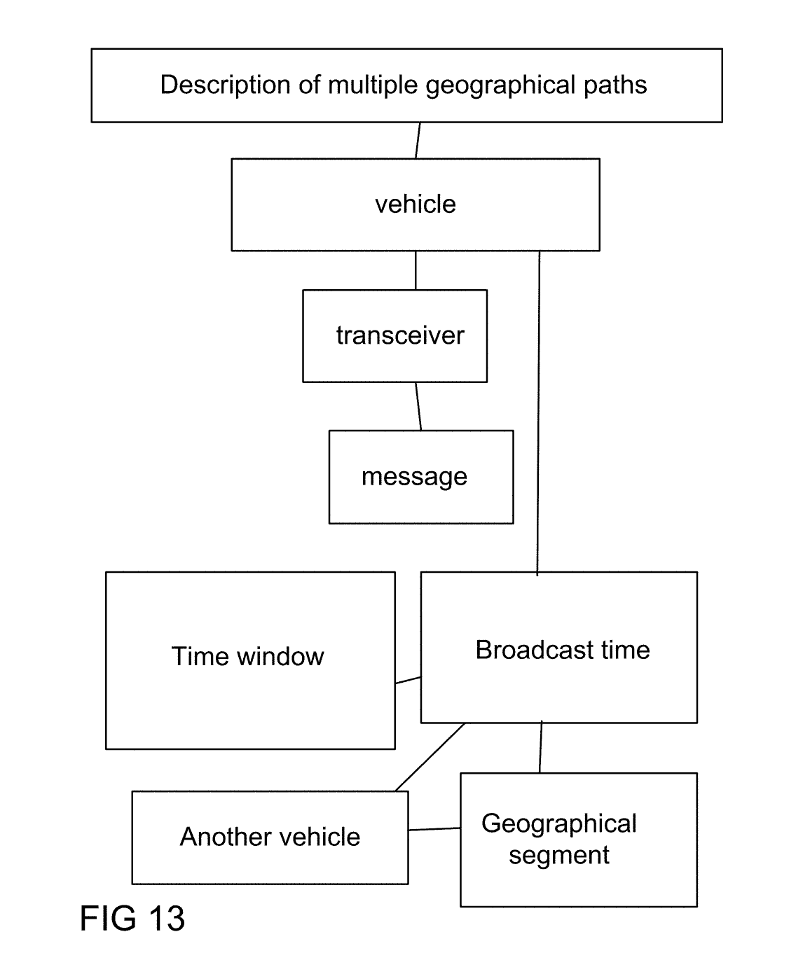

FIG. 10 provides a system for broadcasting, according to an embodiment of the invention. FIG. 11 provides a system for segmentation, according to an embodiment of the invention. FIG. 12 provides a system for re-broadcasting, according to an embodiment of the invention. FIG. 13 provides a system for geographical segmentation, according to an embodiment of the invention.

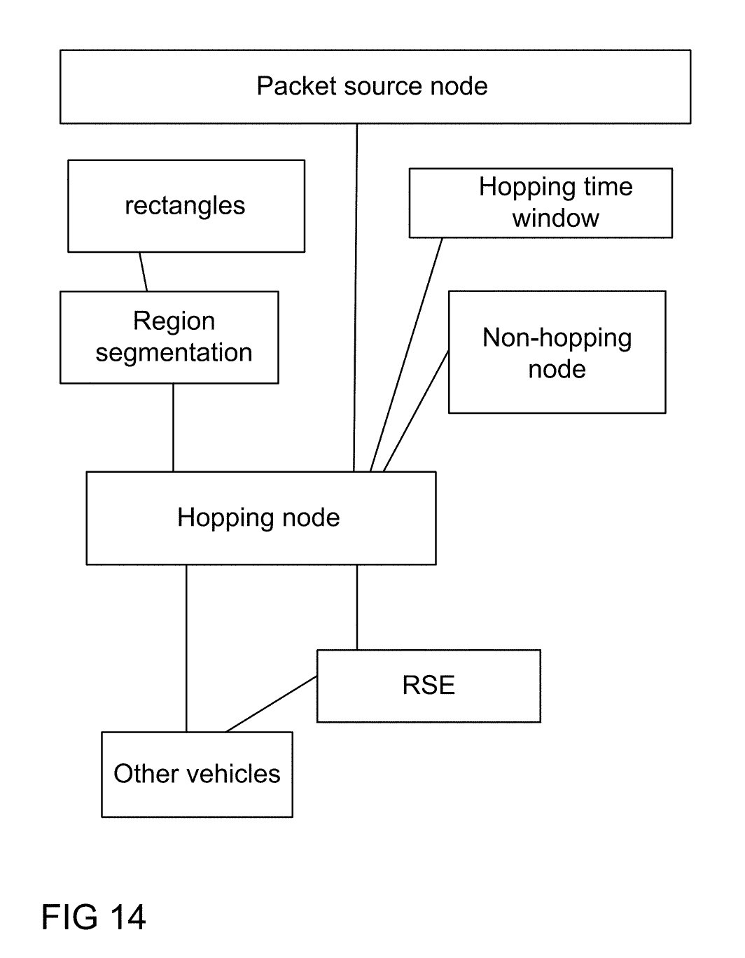

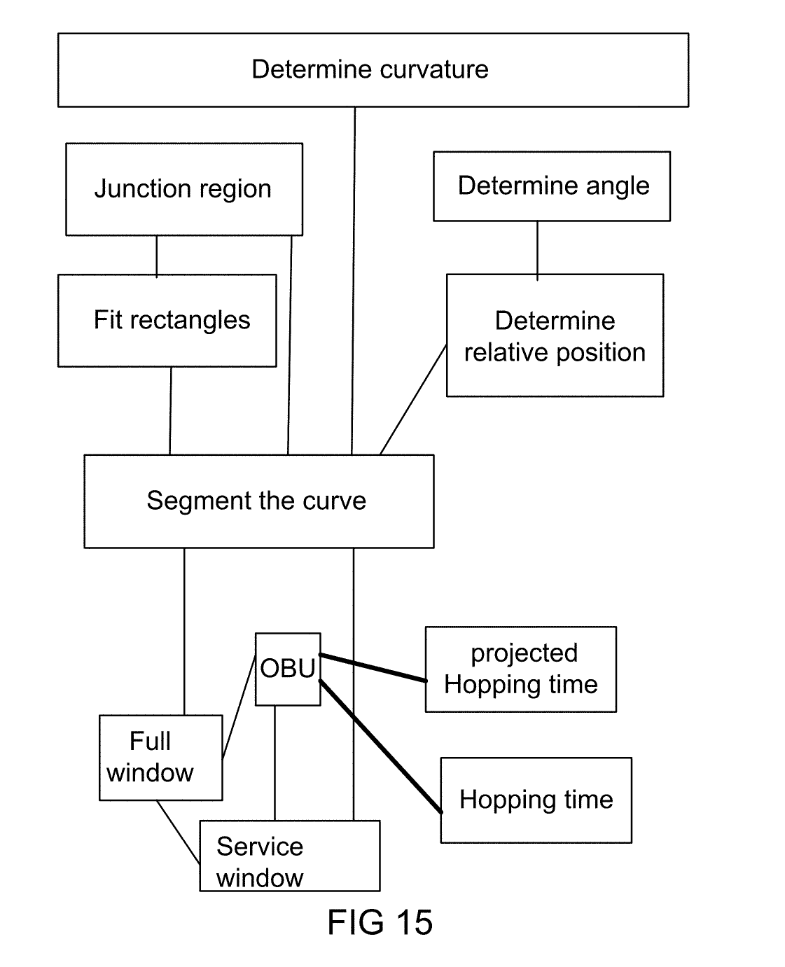

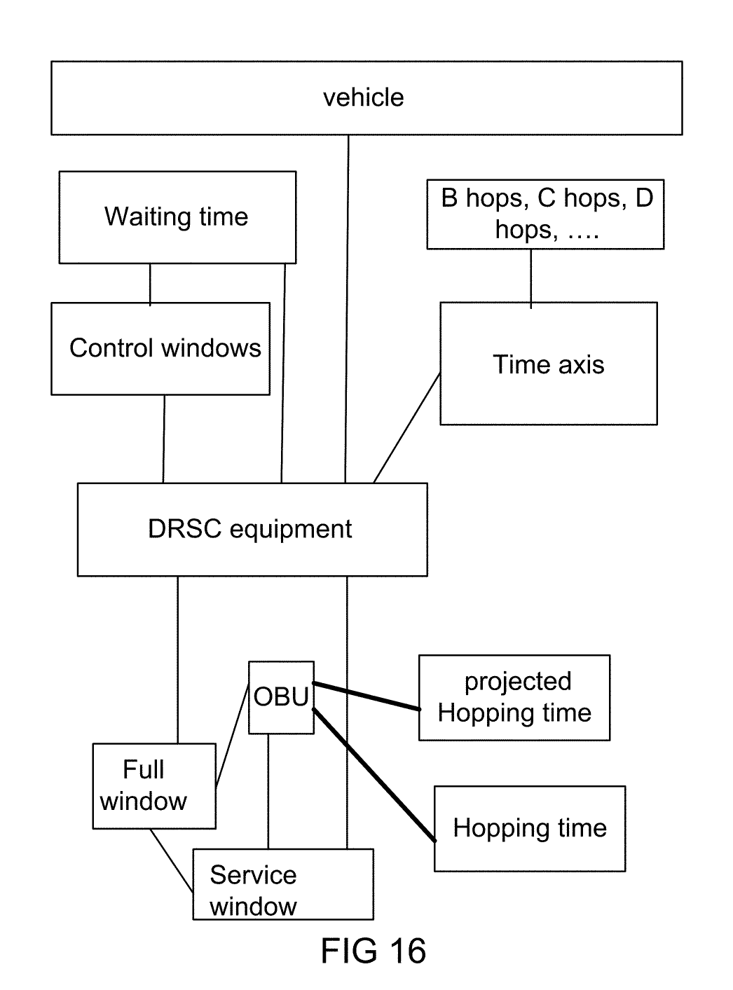

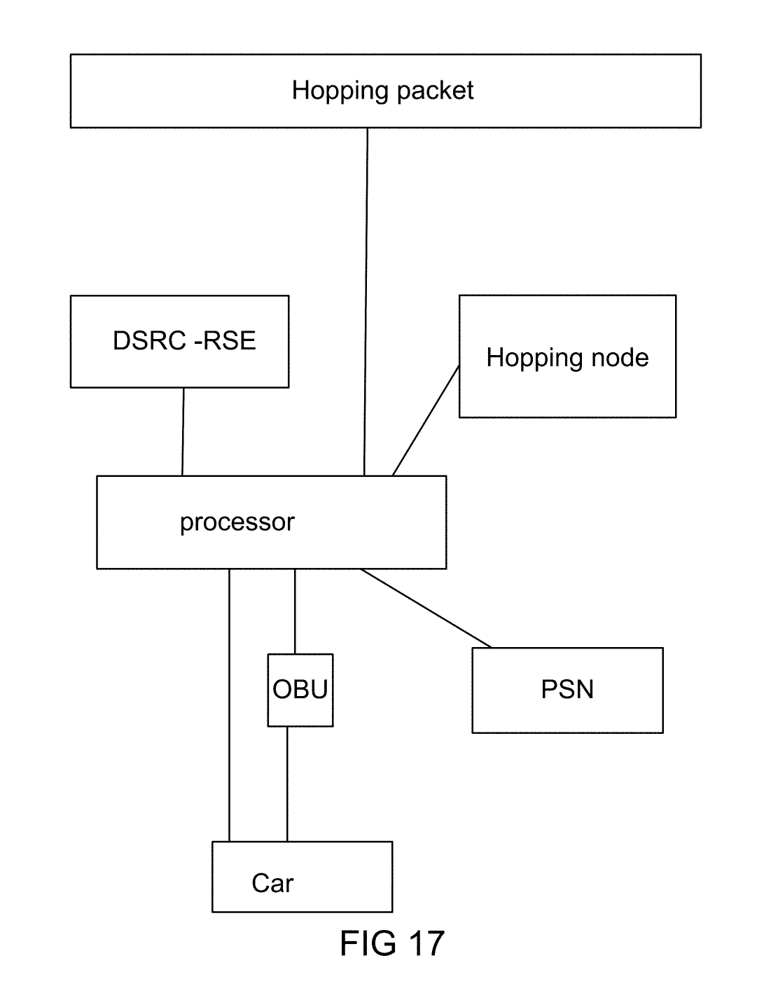

FIG. 14 provides a system for hopping node, according to an embodiment of the invention. FIG. 15 provides a system for segmenting the curve, according to an embodiment of the invention. FIG. 16 provides a system for a vehicle, according to an embodiment of the invention. FIG. 17 provides a system for hopping node, according to an embodiment of the invention.

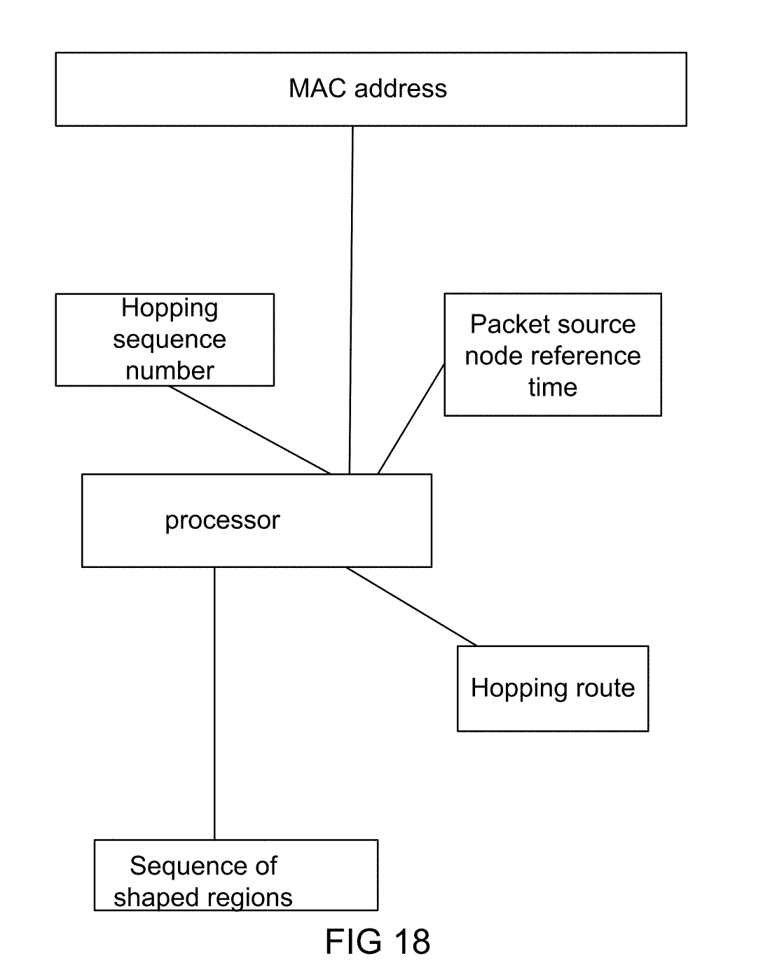

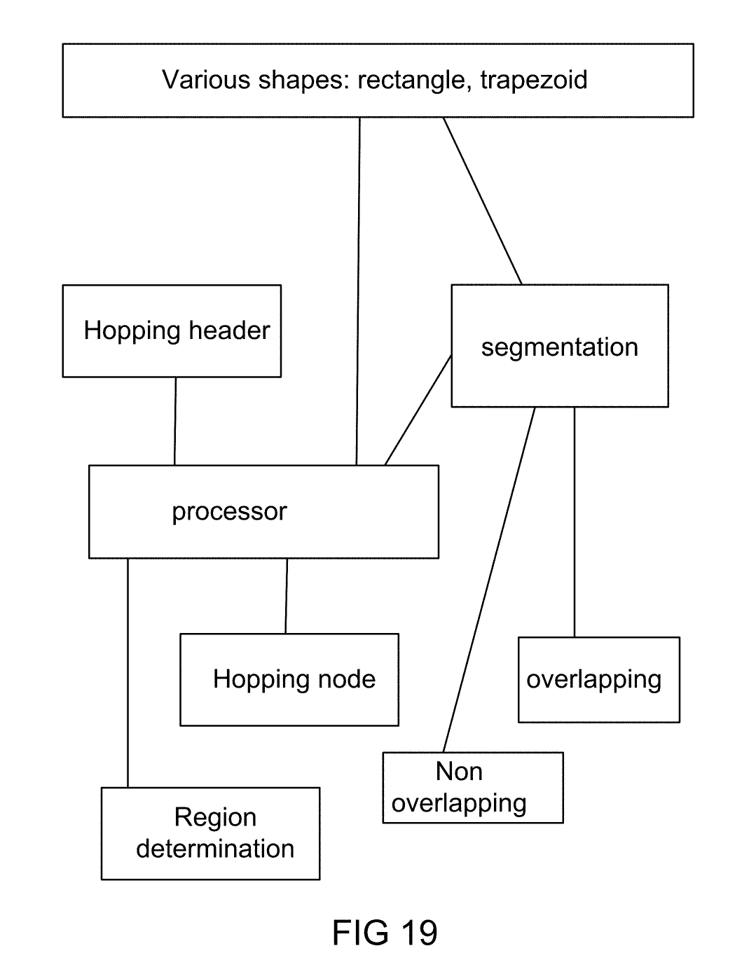

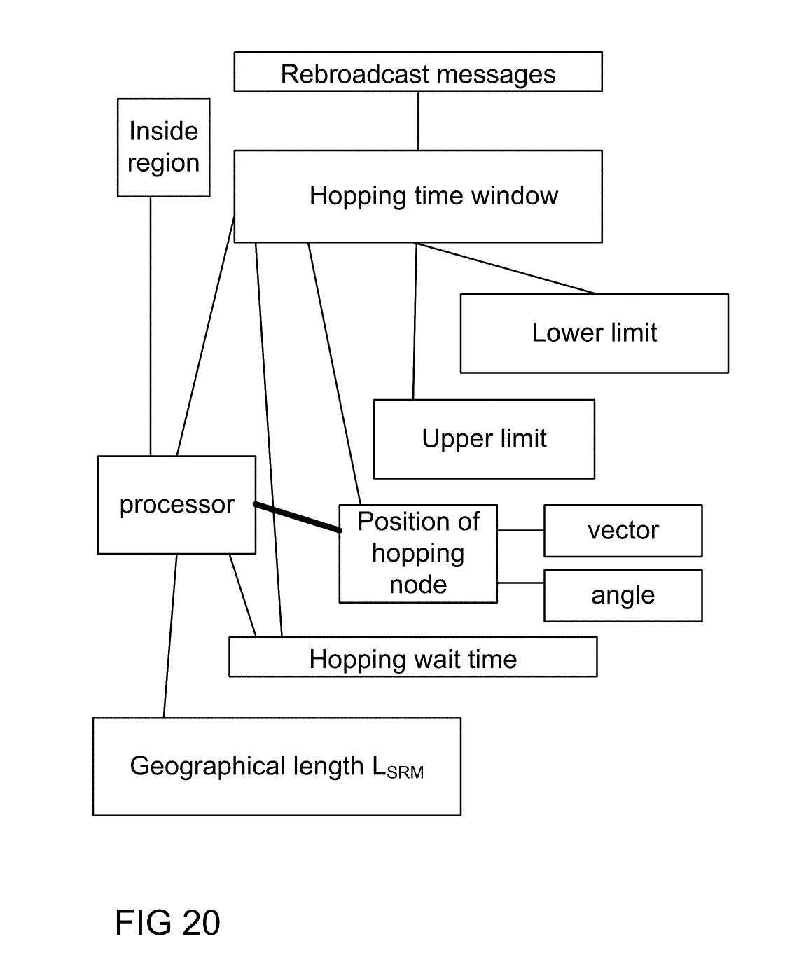

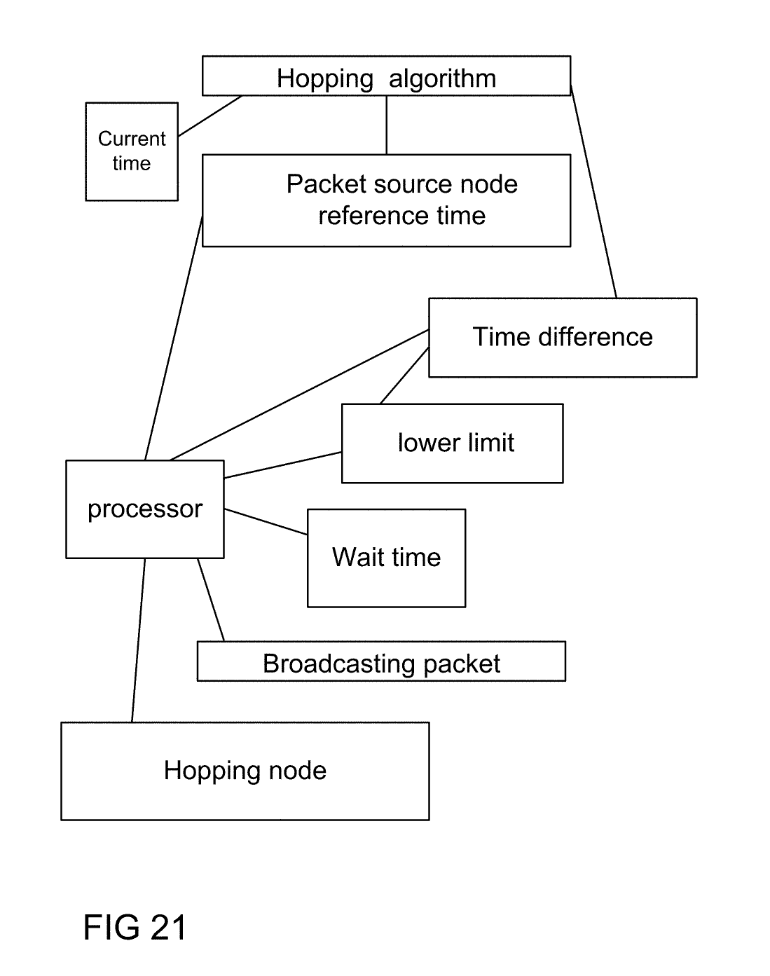

FIG. 18 provides a system for hopping route, according to an embodiment of the invention. FIG. 19 provides a system for region determination, according to an embodiment of the invention. FIG. 20 provides a system for hopping time window, according to an embodiment of the invention. FIG. 21 provides a system for hopping algorithm, according to an embodiment of the invention.

Roadside equipment 902 includes an application processor 916 that executes one or more instructions stored in a memory 917 to communicate with vehicles using vehicle-to-infrastructure communication through a transceiver 918, which in one embodiment is a dedicated short range communication (DSRC) transceiver. Application processor 916 is also able to communicate with a control unit 901 through a wired modem 914 and/or through a wireless modem 912. Roadside equipment 902 may also include a position system 910, such as a Global Positioning System, that allows roadside equipment 902 to determine its position. Memory 917 also includes a description of the segments or regions that form a desired path or route for Hopping Packets.

Transceiver 918 receives messages from one or more vehicles such as Basic Safety Messages (BSMs) and A la Carte messages (ACMs) that indicate the position of the vehicles when the vehicles decelerate at the start of congestion. These messages may be received directly from the reporting vehicle or may be relayed by one or more intermediary vehicles between the reporting vehicle and RSE 902. Processor 916 constructs messages containing information that would be helpful to vehicles or other roadside equipment and transmits the constructed messages using transceiver 918.

Vehicle 904 includes an onboard unit 920, also referred to as a vehicle-to-vehicle communication unit, a vehicle movement sensors/system 936 and a human-machine interface 932. Vehicle movement sensors/system 936 provides information about the vehicle such as the current speed of the vehicle, the status of various vehicle components such as tires, lights, brakes, wipers, and the orientation of the tires, for example. This information is provided to a vehicle services module 934 in onboard unit 920, which provides the information to application processor 928. Application processor 928 is able to communicate wirelessly using a wireless modem 924 to receive updates and to convey history information about vehicle 904. Application processor 928 also receives position information from a position system 922, which in FIG. 9 takes the form of a global positioning system that determines the position of onboard unit 920 based on signals provided by satellites.

Application processor 928 is also able to transmit and receive messages using a transceiver 926, which in FIG. 9 takes the form of a DSRC transceiver. Using transceiver 926, onboard unit 920 is able to receive messages from other vehicles and Roadside equipment. Processor 928 decodes and interprets the messages to determine the content of the messages, such as the traffic parameters. Processor 928 provides some or all of the message content to a human-machine driver 930, which generates human-machine interface 932 to convey some or all of the information in the message to a person in the vehicle. In addition, processor 928 is able to construct additional information based on the traffic information provided by transceiver 926. For example, when transceiver 926 receives the position of the start of congestion or the position of the end of congestion, processor 928 is able to calculate the distance from the vehicle's current location as determined from position system 922 to both the start of congestion and the end of congestion. This additional information may also be provided to human-machine driver 930 so that it can be conveyed to the user through human-machine interface 932.

Processor 928 also rebroadcasts the message it receives from RSE 902 using the methods described above to determine when to rebroadcast the message.

Vehicle 906 is similar to vehicle 904 and includes vehicle movement sensors/systems 956, human-machine interface 952 and onboard unit 940. Onboard unit 940 includes position system 942, wireless modem 944, transceiver 946, memory 949, processor 948, human-machine interface driver 950 and vehicle services module 954, which operate in a similar manner to the components of vehicle 904 discussed above. Using transceiver 946, vehicle 906 is able to receive and rebroadcast messages (Hopping Packets) using the methods described above.

Portable road sign 908 is a hybrid DSRC-PCMS sign that can be moved to different positions along a road and includes a power source 965, roadside equipment (RSE) 960, a display controller 972 and a display 974. RSE 960 acts as a communication link that receives Hopping Packets and rebroadcasts the Hopping Packets using the methods described above. RSE 960 includes an application processor 966, transceiver 968, which in the embodiment of FIG. 9 takes the form of a DSRC transceiver, a position system 962, which in the embodiment of FIG. 9 takes the form of a GPS unit, a wireless modem 964 and a serial port 970. Processor 966 receives messages through transceiver 968. These messages can be received by transceiver 968 directly from RSE 902 or through one or more intermediary vehicles such as vehicles 904 and 906. Processor 966 rebroadcasts the received messages using the methods described above as well as decodes the received message and displays some or all of the information on the display 974.

Although the present invention has been described with reference to preferred embodiments, workers skilled in the art will recognize that changes may be made in form and detail without departing from the spirit and scope of the invention.

What is claimed is:

1. A method of sending messages to vehicles, the method comprising:
receiving a message in a vehicle together with a description of a geographic path that the message is to travel along;
determining the vehicle's geographic position along the geographic path;
determining a message broadcast time for rebroadcasting the message based on the vehicle's geographic position; and
rebroadcasting the message with the description of the geographic path at the message broadcast time.

2. The method of claim 1 wherein the description of the geographic path divides the geographic path into segments and wherein determining a message broadcast time comprises determining a message broadcast time that is within a window of time assigned to a segment that the vehicle is geographically positioned within.

3. The method of claim 2 wherein determining a message broadcast time further comprises dividing the segment that the vehicle is geographically positioned within into sub-segments and determining a message broadcast time that is within a sub-window of time assigned to the sub-segment that the vehicle is geographically positioned within, wherein the sub-window of time is within the window of time assigned to the segment.

4. The method of claim 3 wherein each window of time comprises a plurality of control windows and a plurality of service windows and each sub-window of time is positioned with one of the plurality of service windows.

5. The method of claim 3 wherein the step of rebroadcasting the message is conditioned on the vehicle being the first vehicle in the vehicle's sub-segment to rebroadcast the message, such that the vehicle does not rebroadcast the message if another vehicle in the vehicle's sub-segment rebroadcasts the message first.

6. The method of claim 3 wherein determining a message broadcast time comprises selecting a time within the sub-window of time such that the further the vehicle is from a beginning of the segment, the shorter the wait to the message broadcast time.

7. The method of claim 2 wherein each segment is a geographic shape having an area.

8. The method of claim 7 wherein at least two segments have different areas from each other.

9. The method of claim 1 wherein receiving a message further comprises receiving a description of multiple geographic paths that the message is to travel along.

10. A vehicle comprising:
a transceiver receiving a message and a geographic message path from another vehicle;
a position identification system providing a current geographic position for the vehicle; and
a processor, using the current geographic position and the geographic message path to set a broadcast time for broadcasting the received message and the geographic message path to at least one other vehicle.

11. The vehicle of claim 10 wherein using the current geographic position and the geographic message path to set a broadcast time comprises determining a segment of the path that the vehicle is positioned within, dividing the segment into sub-segments and determining the sub-segment that the vehicle is positioned within.

12. The vehicle of claim 11 further comprising receiving the message and the geographic message path a second time from an additional vehicle, determining that the additional vehicle is within the same sub-segment as the vehicle, and in response, removing the broadcast time.

13. The vehicle of claim 12 wherein determining that the additional vehicle is within the same sub-segment as the vehicle comprises determining that the second time of receiving the message and the geographic message path is within a time window assigned to the sub-segment that the vehicle is positioned within.

14. The vehicle of claim 11 wherein setting the broadcast time comprises determining a time window assigned to the sub-segment the vehicle is within and setting the broadcast time to a time within the time window.

15. The vehicle of claim 14 wherein the broadcast path starts at a source and setting the broadcast time to a time within the time window comprises setting the broadcast time such that the broadcast time is earlier within the time window the further the vehicle is from the source.

16. The vehicle of claim 11 wherein in the transceiver further broadcasts the message and the geographic message path to the at least one other vehicle at the broadcast time.

17. A vehicle-to-vehicle communication system comprising:
a receiver in a vehicle, receiving a message from a second vehicle;
a processor in the vehicle, determining a broadcast time to broadcast the received message and before the broadcast time, the receiver in the vehicle receiving the message a second time from a third vehicle and in response, the processor cancelling the broadcast of the received message at the broadcast time.

18. The vehicle-to-vehicle communication system of claim 17 wherein receiving a message from a second vehicle comprises receiving a description of a path for the message.

19. The vehicle-to-vehicle communication system of claim 18 wherein determining a broadcast time comprises:
identifying a geographic segment of the path that the vehicle is positioned within; and
determining a broadcast time that is within a window of time assigned to the geographic segment.

20. The vehicle-to-vehicle communication system of claim 19 wherein determining the broadcast time further comprises:
dividing a geographic segment of the path into sub-segments;
identifying a geographic sub-segment of the path that the vehicle is within; and
determining a broadcast time that is within a sub-window of time assigned to the geographic sub-segment, wherein the sub-window of time is part of the window of time assigned to the geographic segment that the vehicle is positioned within.

21. The vehicle-to-vehicle communication system of claim 20 wherein cancelling the broadcast of the received message comprises determining that the third vehicle was within the same sub-segment as the vehicle when the third vehicle broadcast the message.

22. A method for vehicle communication, said method comprising:
inputting coordinates of a road;
a processor segmenting said road to get a segmented road;
said processor fitting one or more rectangles on said segmented road;
receiving hopping packet with respect to hopping node;
determining which region or segment corresponds to said hopping node.

23. The method for vehicle communication as recited in claim 22, said method comprising:
receiving current time.

24. The method for vehicle communication as recited in claim 22, said method comprising:
receiving packet source node reference time.

25. The method for vehicle communication as recited in claim 22, said method comprising:
calculating difference of time.

26. The method for vehicle communication as recited in claim 22, said method comprising:
calculating lower limit of sub-region hopping time window.

27. The method for vehicle communication as recited in claim 22, said method comprising:
calculating hopping node's hopping wait time.

28. The method for vehicle communication as recited in claim 22, said method comprising:
comparing to lower limit of sub-region hopping time window.

29. The method for vehicle communication as recited in claim 22, said method comprising:
determining a direction of a vector or an angle.
